(19) United States
(12) Patent Application Publication
(10) Pub. No.: US 2012/0094103 A1
(43) Pub. Date: Apr. 19, 2012

(54) MANGANESE-RICH AND MAGNESIUM-RICH ALUMINIUM STRIP

(75) Inventors: Bernhard Kernig, Koln (DE); Jochen Hasenclever, Bonn (DE); Gerd Steinhoff, Bonn (DE); Christoph Settele, Monchengladbach (DE)

(73) Assignee: HYDRO ALUMINIUM DEUTSCHLAND GMBH, Bonn (DE)

(21) Appl. No.: 13/278,540

(22) Filed: Oct. 21, 2011

Related U.S. Application Data
(63) Continuation of application No. PCT/EP2010/055434, filed on Apr. 23, 2010.

(30) Foreign Application Priority Data
Apr. 24, 2009 (EP) 09158702.2

(51) Int. Cl. B32B 3/00; C22F 1/047; C22C 21/00; C22F 1/04

(52) U.S. Cl. 428/220; 148/692; 420/532; 420/541

(57) ABSTRACT

The invention relates to an aluminium alloy for producing lithographic printing plate supports. The object of providing an aluminium alloy and an aluminium strip made of an aluminium alloy which make it possible to produce printing plate supports having improved flexural fatigue strength transverse to the rolling direction and having improved heat resistance, without impairing roughening properties, is achieved for an aluminium alloy in that the aluminium alloy contains the following alloy components in percent by weight:

0.2%≦Fe≦0.5%,

0.41%≦Mg≦0.7%,

0.05%≦Si≦0.25%,

0.31%≦Mn≦0.6%,

Cu≦0.04%,

Ti<0.1%,

Zn≦0.1%,

Cr≦0.1%,

the rest being Al and unavoidable impurities, each in an amount of 0.05% at most to give a total of 0.15% at most.

### CROSS-REFERENCE TO RELATED PATENT APPLICATIONS

This patent application is a continuation of PCT/EP2010/055434, filed Apr. 23, 2010, which claims priority to European Application No. 09158702.2, filed Apr. 24, 2009, the entire teachings and disclosure of which are incorporated herein by reference thereto.

### FIELD OF THE INVENTION

The invention relates to an aluminium alloy for producing lithographic printing plate supports as well as an aluminium strip produced from the aluminium alloy, a method for producing the aluminium strip and use thereof to produce lithographic printing plate supports.

### BACKGROUND OF THE INVENTION

Aluminium strips for the production of lithographic printing plate supports must be of very high quality and are therefore subject to constant development. The aluminium strip must satisfy a complex profile of properties. The aluminium strip is thus subjected to electrochemical roughening during the production of the lithographic printing plate support, which roughening process has to ensure an unstructured appearance without streaking effects at maximum processing speed. The purpose of the roughened structure of the aluminium strip is to enable photosensitive layers, which are then illuminated, to be permanently applied to the printing plate support. The photolayers are burned in at temperatures of 220° C. to 300° C. over a period of 3 to 10 min. Typical combinations of burning-in times and temperatures are, for example, 240° C. for 10 min or 280° C. for 4 min. It must then also be possible to easily handle the printing plate support so as to enable a clamping of the printing plate support in the printing device. The softening of the printing plate support after the burning-in process may therefore not be too pronounced. A maximum tensile strength before the burning-in process may ensure that the tensile strength after the burning-in process is sufficiently high. However, a high tensile strength before the burning-in process hinders the alignment of the aluminium strip, that is to say the elimination of a “coil-set” of the aluminium strip before the processing to form the printing plate support. In addition, printing machines with maximum printing areas are increasingly used, and therefore printing plate supports no longer have to be clamped lengthwise to the rolling direction, but transverse to the rolling direction so as to provide extra-large printing widths. This means that the flexural fatigue strength of the printing plate support is increasingly important transverse to the rolling direction. In order to optimise the properties of the aluminium strip in terms of its capacity for roughening, its heat resistance, mechanical properties before and after the burning-in process as well as its flexural fatigue strength lengthwise to the rolling direction, a strip for producing lithographic printing plate supports which is characterised by a good capacity for roughening combined with a high flexural fatigue strength lengthwise to the rolling direction and sufficient thermal stability is known from European patent EP 1 065 071 B1, which originates from the applicant. Owing to the increasing size of the printing machines and the resultant enlargement of the printing plate supports required, however, it has become necessary to improve the properties of the aluminium alloys and the printing plate supports produced therefrom in terms of softening transverse to the rolling direction without negatively influencing the capacity for roughening of the aluminium strip.

It is also known from international patent application WO 2007/045676, which also originates from the applicant, to combine high iron contents 0.4% by weight to 1% by weight with a relatively high manganese content and with magnesium contents of up to 0.3% by weight at most. Heat resistance and flexural fatigue strength lengthwise to the rolling direction after a burning-in process could be improved using this aluminium alloy. However, it was previously assumed that in particular manganese and magnesium contents of more than 0.3% by weight are problematic in terms of the capacity of the aluminium alloy for roughening.

### SUMMARY OF THE INVENTION

Based on this, the object underlying the present invention is to provide an aluminium alloy and an aluminium strip which enable the production of printing plate supports having improved flexural fatigue strength transverse to the rolling direction and having improved heat resistance, without impairing the roughening properties. At the same time, the present invention is based on the problem of providing a production method for an aluminium strip which is well adapted in particular for the production of lithographic printing plate supports which are to be clamped transversely.

### BRIEF DESCRIPTION OF THE DRAWINGS

FIG. 1a shows a schematic view of a flexural fatigue device, used to determine a number of possible flexural fatigue cycles; and

FIG. 1b shows in cross section a schematic illustration of the operation of the flexural fatigue device of FIG. 1a.

### DETAILED DESCRIPTION OF THE INVENTION

In accordance with a first teaching of the present invention the above-described object of an aluminium alloy for producing lithographic printing plate supports is achieved in that the aluminium allow contains the following alloy components, in % by weight:

0.2%≦Fe≦0.5%,

0.11%≦Mg≦0.7%,

0.05%≦Si≦0.25%,

0.31%≦Mn≦0.6%,

Cu≦0.04%,

Ti<0.1%,

Zn≦0.1%,

Cr≦0.1%,

the rest being Al and unavoidable impurities, each in an amount of 0.05% at most to give a total of 0.15% at most.

In contrast to the previously used aluminium alloys for production of lithographic printing plate supports, which contain very low proportions of manganese and magnesium on the whole, the present aluminium alloy according to the invention combines high manganese contents of at least 0.31% by weight with relatively high magnesium contents of 0.1 to 0.7% by weight. As a result, it has been found that the aluminium alloy according to the invention not only exhibits very good flexural fatigue strength transverse to the rolling direction owing to the combination of high manganese and magnesium contents. Owing to excellent heat resistance, the printing plate supports produced from the aluminium alloy according to the invention can be easily handled, and process reliability during the production process to ensure the mechanical properties before and after the burning-in process is particularly high. In spite of the permissible high manganese and magnesium values, experts have not encountered any problem in terms of capacity for roughening, contrary to expectations.

Good roughening behaviour is also produced by silicon, which is contained in the aluminium alloy according to the invention in an amount of 0.05% by weight to 0.25% by weight. During electrochemical roughening or etching, the Si content according to the invention ensures that a high number of sufficiently deep recesses are produced so as to guarantee optimal absorption of the photosensitive varnish.

Copper should be limited to a maximum of 0.04% by weight so as to avoid inhomogeneous structures during the roughening process. Titanium, which is introduced into the aluminium alloy for grain refinement of the melt, leads to problems during roughening at higher contents of more than 0.1% by weight. The contents of zinc and chromium have a negative effect on the roughening result and should therefore be present in an amount of 0.1% by weight at most.

In accordance with a first embodiment of the aluminium alloy according to the invention, the heat resistance of the aluminium alloy can be further increased since the aluminium alloy contains the following Mn content in % by weight:

0.5%≦Mn≦0.6%.

It has also been found that higher manganese contents do not only lead to further improvement of heat resistance, that is to say to lesser softening after a burning-in process, but simultaneously stabilise the flexural fatigue strength transverse to the rolling direction with regard to the selected production method. This effect is particularly pronounced with a manganese content of 0.5% to 0.6% by weight.

In accordance with a next embodiment of the aluminium alloy according to the invention, said alloy has an Mg content in % by weight of:

0.5%≦Mg≦0.7%,

and the flexural fatigue strength transverse to the rolling direction can thus be increased once again. No problems in terms of the capacity for electrochemical roughening of the aluminium strips produced from a corresponding aluminium alloy have been observed either with higher manganese contents, for example of at least 0.5% by weight, or in combination with magnesium contents of at least 0.5% by weight.

As already mentioned, Ti, Zn and Cr may negatively affect the roughening result and in principle may lead to streaking effects on the aluminium strips. The aluminium alloy according to the invention may thus be improved further in terms of process reliability during roughening, and therefore with regard to the use thereof for printing plate supports since the aluminium alloy contains the following alloy components in % by weight:

Ti≦0.05%,

Zn≦0.05%,

Cr<0.01%.

In accordance with a second teaching of the present invention, the above-mentioned object is achieved by an aluminium strip for producing lithographic printing plate supports consisting of an aluminium alloy according to the invention having a thickness of 0.15 mm to 0.5 mm. The aluminium strip according to the invention is characterised not only by its excellent capacity for roughening, but guarantees optimised handling ability with regard to the use of extra-large printing devices with transversely clamped printing plate supports owing to the very good heat resistance with moderate tensile strength values. Above all, the excellent flexural fatigue strength transverse to the rolling direction of the aluminium strip according to the invention adds to this.

In accordance with a further embodiment of the aluminium strip according to the invention, after a burning-in process at a temperature of 280° C. and for a period of 4 min, said strip has a tensile strength Rm of more than 150 MPa, a proof stress Rp 0.2 of more than 140 MPa and a flexural fatigue strength transverse to the rolling direction of at least 1950 cycles in a flexural fatigue test. Since the aluminium strip according to the invention exhibits very good heat resistance, it is possible to adjust the tensile strength values before the burning-in process in an ideal processing range using conventional method parameters, for example so as to correct a “coil set” and at the same time to enable excellent handling ability and stability during use in extra-large printing devices.

Owing to the above-described property profile of the aluminium alloy and the aluminium strips produced therefrom, in accordance with a third teaching of the present invention the above-mentioned object is also achieved by the use of the aluminium strip according to the invention to produce lithographic printing plate supports.

Lastly, in accordance with a fourth teaching of the present invention, the above-mentioned object is achieved by a method for producing an aluminium strip for lithographic printing plate supports consisting of an aluminium alloy according to the invention in that a rolled ingot is cast, the rolled ingot is optionally homogenised at a temperature of 450° C. to 610° C., the rolled ingot is hot-rolled to a thickness of 2 to 9 mm and the hot-rolled strip is cold-rolled, either with or without intermediate annealing, to a final thickness of 0.15 mm to 0.5 mm. The intermediate annealing process, if intermediate annealing is carried out, is conducted in such a way that a desired final strength of the aluminium strip in the final rolled state is set by the subsequent cold-rolling process carried out to a final thickness.

An intermediate annealing is preferably carried out at an intermediate thickness of 0.5 to 2.8 mm, wherein the intermediate annealing is carried out in the coil or in a continuous furnace at a temperature of 230° C. to 470° C. As a result of this intermediate annealing, the final strength of the aluminium strip in the final rolled state can be adjusted depending on the thickness of the strip at which the intermediate annealing is carried out. A concluding annealing process can preferably be omitted so as to keep production costs as low as possible.

Owing to the aluminium alloy according to the invention, in conjunction with the parameters just described, the flexural fatigue strength transverse to the rolling direction is very high, and at the same time a softening of the aluminium strip caused by the compulsory burning-in process is reduced. As a result, printing plate supports can be provided by the method according to the invention which, in addition to excellent capacity for roughening, also combine excellent heat resistance with a high flexural fatigue strength transverse to the rolling direction.

There are now a large number of possibilities for providing and developing the aluminium alloy according to the invention, the aluminium strip according to the invention, the use thereof and the method for producing the aluminium strip. For this purpose reference is made to the claims subordinate to claims 1, 6 and 9 and to the description of embodiments in conjunction with the drawings.

The single FIGURE of the drawing shows a schematic sectional view of the device used to determine the flexural fatigue strength.

Table 1 now shows the alloy composition of a reference aluminium alloy Ref and aluminium alloys according to the invention I5, I6 and I7, which were also examined. The composition values in Table 1 are given in percent by weight.

TABLE 1

| Alloy | Si | Fe | Cu | Mn | Mg | Cr | Zn | Ti | Remainder |
|---|---|---|---|---|---|---|---|---|---|
| Ref | 0.08 | 0.35 | <0.002 | 0.0075 | 0.2 | <0.003 | 0.012 | 0.0075 | 0.0075 |
| I5 | 0.08 | 0.35 | <0.002 | 0.5 | 0.2 | <0.003 | 0.012 | 0.0075 | 0.0075 |
| I6 | 0.08 | 0.35 | <0.002 | 0.5 | 0.41 | <0.003 | 0.012 | 0.0075 | 0.0075 |
| I7 | 0.08 | 0.35 | <0.002 | 0.5 | 0.6 | <0.003 | 0.012 | 0.0075 | 0.0075 |

The alloys I5, I6 and I7 according to the invention contain a much higher manganese content of 0.5% by weight compared to the reference aluminium alloy. The Mg content was varied from 0.2% by weight to 0.6% by weight. Rolled ingots were cast from the aluminium alloys having the compositions just mentioned. The rolled ingot was then homogenised at a temperature of 450° C. to 610° C. and hot-rolled to a hot strip thickness of 4 mm. The col-rolling to a final thickness of 0.3 mm was carried out both without and with intermediate annealing, wherein the intermediate annealing was carried out at a strip thickness of 0.9 to 1.2 mm, preferably at 1.1 mm. Two different temperature ranges were used during the intermediate annealing, specifically 300° C. to 350° C. and 400° C. to 450° C.

The aluminium strips produced in accordance with the method just described were subjected to an electrochemical roughening in order to examine suitability for the production of printing plate supports. Surprisingly and contrary to the expectations of experts, no negative indications with regard to any streaking effects were observed after the roughening process, even with the relatively high magnesium and manganese contents of the aluminium alloys according to the invention. The aluminium alloys according to the invention are therefore all characterised by very good or good roughening behaviour. The results of the roughening tests are shown in Table 2.

TABLE 2

| Alloy | Roughening behaviour |
|---|---|
| Ref | ++ |
| I5 | ++ |
| I6 | + |
| I7 | + |

Table 3 shows the results of the flexural fatigue test as well as the associated values for intermediate annealing thickness and the intermediate annealing temperature ranges.

TABLE 3

| | | | | Flexural fatigue cycles | |
|---|---|---|---|---|---|
| | | | | transverse to the | |
| | | Thickness | Temperature | rolling direction | |
| | | of the | of the | final | burned-in |
| | Test | intermediate | intermediate | rolled | state (280° |
| Alloy | no. | annealing (mm) | annealing (° C.) | state | C./4 min) |
| Ref | R | 2.2 | 400-450 | 1928 | 1274 |
| I5 | 5.1 | — | — | 2252 | 2300 |
| I5 | 5.2 | 0.9-1.2 | 300-350 | 2716 | 2857 |
| I5 | 5.3 | 0.9-1.2 | 400-450 | 2210 | 2406 |
| I6 | 6.1 | — | — | 3208 | 2425 |
| I6 | 6.2 | 0.9-1.2 | 300-350 | 2808 | 3099 |
| I6 | 6.3 | 0.9-1.2 | 400-450 | 2937 | 3599 |
| I7 | 7.1 | — | — | 4951 | 2958 |
| I7 | 7.2 | 0.9-1.2 | 300-350 | 3506 | 3372 |
| I7 | 7.3 | 0.9-1.2 | 400-450 | 3058 | 3230 |

As Table 3 shows clearly, the number of possible bending cycles both in the final rolled state and in the burned-in state could be increased considerably compared to the reference alloy. At 2300 cycles, the minimal number of bending cycles transverse to the rolling direction in the burned-in state is 1.8 times higher than with the reference alloy. The aluminium alloy according to the invention is thus particularly well adapted for the production of extra-large printing plate supports which are clamped in printing devices transverse to the rolling direction.

An improved heat resistance was also produced with the high manganese contents, which was particularly noticeable in the form of higher values for tensile strength and proof stress. The mechanical properties of the alloy examples are given in Table 4. They were measured in accordance with the EN standard.

TABLE 4

Burned-in at 280° C./4 min, measured
lengthwise to the rolling direction

| Test no. | Rp 0.2 (Mpa) | Rm (Mpa) |
|---|---|---|
| R | 136 | 145 |
| 5.1 | 180 | 193 |
| 5.2 | 153 | 170 |
| 5.3 | 148 | 164 |
| 6.1 | 181 | 192 |
| 6.2 | 154 | 170 |
| 6.3 | 151 | 169 |
| 7.1 | 178 | 193 |
| 7.2 | 162 | 182 |
| 7.3 | 161 | 179 |

The influence of the intermediate annealing on the values Rm and Rp 0.2 is evident. The highest values for tensile strength Rm and proof stress Rp 0.2 can be found in tests 5.1, 6.1 and 7.1. This is to be attributed to the production of the strips without intermediate annealing. The intermediate annealing at 0.9 mm to 1.2 mm, preferably at 1.1 mm gave moderate values for tensile strength and proof stress after the burning-in process, wherein the values were reduced once again with increasing intermediate annealing temperature, as demonstrated by practical examples 5.3, 6.3 and 7.3.

All measured values for tensile strength Rm and proof stress RP 0.2 of the aluminium strips according to the invention are considerably above the previously obtained values of the reference alloy in the test R, although a smaller thickness for the intermediate annealing was selected in the aluminium strips according to the invention at the same intermediate annealing temperature.

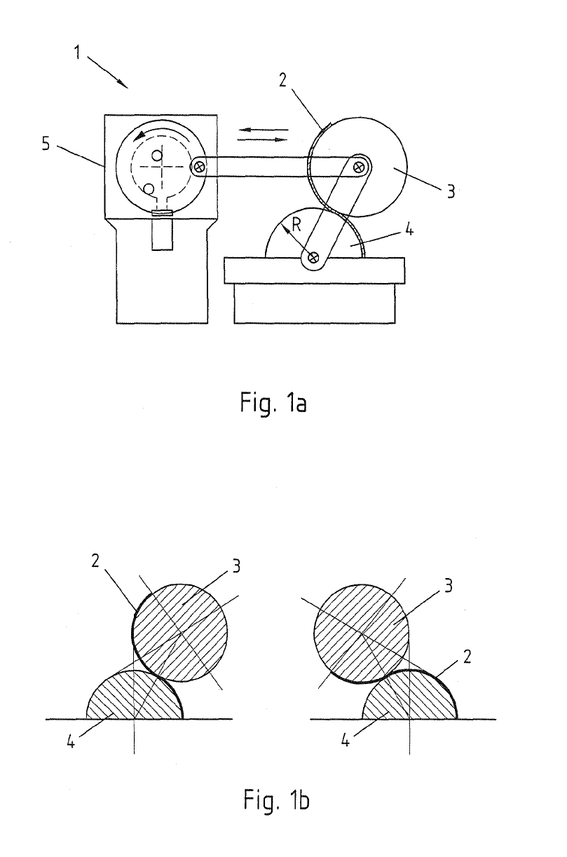

FIG. 1a now shows a schematic view of the flexural fatigue device 1, which was used to determine the number of possible flexural fatigue cycles. The flexural fatigue device 1 consists of a movable segment 3 which is arranged on a fixed segment 4 in such a way that the segment 3 is moved back and forth during the flexural fatigue test by a rolling movement over the fixed segment 4 so that the fixed sample 2 is subjected to bending at right angles to the extension of the sample, FIG. 1b. In order to examine the flexural fatigue strength transverse to the rolling direction, a sample must be cut out from the aluminium strip according to the invention merely transverse to the rolling direction and clamped in the flexural fatigue device 1. The radius of the segments 3, 4 is 30 mm. The number of bending cycles was measured, wherein the bending cycle was terminated upon reaching the starting position of the segment 3.

The measurements of the flexural fatigue strength of the alloys according to the invention clearly showed that the number of bending cycles can generally be increased with increased manganese and magnesium contents, wherein a high number of bending cycles was also achieved without intermediate annealing processes, until the sample cracked. In particular, the number of bending cycles achieved when carrying out intermediate annealing in the final rolled state significantly approximated that achieved in the burned-in state with higher manganese and magnesium contents. In this regard a positive effect of the manganese and magnesium contents on the mechanical properties of the aluminium strips according to the invention could be observed.

1. Lithographic printing plate support comprising an aluminium alloy, wherein the aluminium alloy contains the following alloy components in percent by weight:
0.2%≦Fe≦0.5%,
0.41%≦Mg≦0.7%,
0.05%≦Si≦0.25%,
0.31%≦Mn≦0.6%,
Cu≦0.04%,
Ti<0.1%,
Zn≦0.1%,
Cr≦0.1%,
the rest being Al and unavoidable impurities, each in an amount of 0.05% at most to give a total of 0.15% at most.

2. Lithographic printing plate support according to claim 1, wherein the aluminium alloy contains the following Mn content in percent by weight:
0.5%≦Mn≦0.6%.

3. Lithographic printing plate support according to claim 1, wherein the aluminium alloy has the following Mg content in percent by weight:
0.5%≦Mg≦0.7%.

4. Lithographic printing plate support according to claim 1 wherein the aluminium alloy contains the following alloy components in percent by weight:
Ti≦0.05%,
Zn≦0.05%,
Cr≦0.01%.

5. Lithographic printing plate support according to claim 1, wherein the lithographic printing plate support has a thickness of 0.15 mm to 0.5 mm.

6. Lithographic printing plate support according to claim 5, wherein, after a burning-in process at a temperature of 280° C. and over a period of 4 minutes, the lithographic printing plate support has a tensile strength Rm of more than 150 MPa, a proof stress Rp 0.2 of more than 140 MPa as well as a flexural fatigue strength transverse to the rolling direction of at least 1950 cycles in the flexural fatigue test.

7. A method for producing an aluminium strip for lithographic printing plate supports according to claims 1, comprising wherein a rolled ingot is cast, the rolled ingot is optionally homogenised at a temperature of 450° C. to 610° C., the rolled ingot is hot-rolled to a thickness of 2 to 9 mm and the hot strip is cold-rolled, either with or without intermediate annealing, to a final thickness of 0.15 mm to 0.5 mm.

8. The method according to claim 7, wherein intermediate annealing is carried out at an intermediate thickness of 0.5 mm to 2.8 mm, preferably between 0.9 mm and 1.2 mm, and the intermediate annealing takes place in the coil or in a continuous furnace at a temperature of 230° C. to 470° C.
